(19) United States
(12) Patent Application Publication
(10) Pub. No.: US 2018/0290272 A1
(43) Pub. Date: Oct. 11, 2018

(54) SOCKETS, TOOLS, AND METHODS FOR DECOUPLING THREADABLY COUPLED COMPONENTS

(71) Applicant: Larry Gene Eubank, Bloomington, IN (US)

(72) Inventor: Larry Gene Eubank, Bloomington, IN (US)

(21) Appl. No.: 15/700,572

(22) Filed: Sep. 11, 2017

Related U.S. Application Data
(60) Provisional application No. 62/482,577, filed on Apr. 6, 2017.

(51) Int. Cl. B25B 23/10; B25B 23/00; B25B 13/06

(52) U.S. Cl. CPC B25B 23/108; B25B 13/06; B25B 23/0035

(57) ABSTRACT

Sockets, tools, and methods for decoupling threadably coupled components. The sockets have an open end sized to receive a distal portion of a first component having threads thereon, a closed end oppositely disposed from the open end, and an interior wall therebetween that defines a cavity. An interior surface of the interior wall has threads thereon configured to threadably couple with the threads of the first component. The tools include a handle configured for rotating the socket about its axis of rotation. The sockets and tools may be used by threadably coupling at least the distal portion of the first component into the opening of the open end of the socket, rotating the socket until the first component contacts a barrier at the closed end of the socket, and then simultaneously applying counter-rotational forces to the socket and a second component such that the first and second components threadably decouple.

### CROSS REFERENCE TO RELATED APPLICATIONS

This application claims the benefit of U.S. Provisional Application No. 62/482,577, filed Apr. 6, 2017, the contents of which are incorporated herein by reference.

### BACKGROUND OF THE INVENTION

The present invention generally relates to handheld tools. The invention particularly relates to a handheld tool for decoupling two threadably coupled components, such as removing a nut from a bolt.

A common problem encountered when attempting to disassemble an assembly held together with a nut and bolt combination is that the nut is difficult to remove from the bolt, for example, due to rust, such that upon applying a rotational force to the nut in an attempt to remove it from the bolt, the bolt rotates with the nut instead of the nut rotating on the threads of the bolt. If the head of the bolt can be gripped to prevent its rotation, it may be possible to force the nut to rotate on the bolt threads until the nut can be removed. However, it may be difficult to remove the nut from a bolt if it is not possible or practical to prevent the bolt from rotating.

The above scenario may arise under a variety of circumstances, including bolts with a head that has been stripped or rounded, or carriage bolts that no longer grip the hole in a part in which they are installed. Similarly, the problem may arise where the head of the bolt is in good condition, but cannot be accessed or gripped due to the location or position of the head, that is, access is prevented due to obstacles. In these cases, and others, it may be difficult or impossible to grip the head of the bolt to keep the bolt from turning when the nut is rotated. Moreover, gripping the bottom or distal end (e.g., oppositely disposed from the head) of the bolt may also be problematic because common gripping tools, such as pliers and the like, may damage the threads and make it difficult to later pass the nut over the damaged portion of the bolt.

Several remedies to this problem have been proposed. One remedy is to attach a grippable structure to the head of the nut. For example, welding a spare nut to a stripped or rounded head of a bolt may allow the head to be gripped by gripping the attached nut. Similarly, welding or otherwise attaching a rough surface feature to a stripped or rounded head of the bolt may allow the surface feature to be gripped sufficiently to keep the bolt from rotating with the nut.

Alternatively, cutting or removing some material from the head of the bolt may allow the head to be held to prevent rotation of the bolt. For example, a slot may be cut in the head to allow the head to be held with a screwdriver to prevent rotation of the bolt. Alternatively, edges may be cut into the exterior of the head to allow the head to be gripped by pliers or a wrench.

The remedies available to date are difficult to use, and typically add many minutes, and potentially hours, to the time needed to complete the disassembly. Available remedies also are commonly expensive and/or may require expensive equipment. Further, the above noted remedies do not address the situation wherein access to the head of the bolt is limited.

In view of the above, it can be appreciated that there are certain problems, shortcomings or disadvantages associated with the prior art, and that it would be desirable if systems and methods were available for removing a nut from a bolt that tends to rotate with the nut as the nut is turned with a tool.

### BRIEF DESCRIPTION OF THE INVENTION

The present invention provides sockets, tools, and methods suitable for decoupling two threadably coupled components, for example, a nut and bolt assembly in which the bolt is prone to rotating with the nut when attempting to remove the nut from the bolt.

According to one aspect of the invention, a tool for decoupling first and second components that are threadably coupled is provided that includes a socket having an open end having an opening sized to receive at least a distal portion of the first component having first threads thereon, a closed end oppositely disposed from the open end, and an interior wall therebetween that defines a cavity. An interior surface of the interior wall has second threads thereon configured to threadably couple with the first threads of the first component. The socket has an axis of rotation. The tool includes a handle configured for rotating the socket about its axis of rotation.

According to another aspect of the invention, a method of decoupling first and second components that are threadably coupled is provided that includes providing a tool that includes a socket having an open end having an opening, a closed end oppositely disposed from the open end, and an interior wall therebetween that defines a cavity, and a handle configured for rotating the socket about an axis of rotation thereof. The method includes inserting at least a distal portion of the first component having first threads thereon into the opening of the open end of the socket, rotating the socket about an axis of rotation thereof to threadably couple second threads on an interior surface of the interior wall of the socket with the first threads of the first component, continuing to rotate the socket until the first component contacts a barrier at the closed end of the socket, and then simultaneously applying a counter-rotational force to the socket and second component, for example, by applying a rotational force to the socket with the handle while holding the second component in a fixed location, or holding the socket in a fixed position with the handle while applying a rotational force to the second component, such that the second component threadably decouples from the first component.

According to another aspect of the invention, a socket configured to couple with a tool is provided that includes an open end having an opening, a closed end oppositely disposed from the open end, and an interior wall between the open end and the closed end that defines a cavity. An interior surface of the interior wall has threads thereon configured to threadably couple with a distal end of a threaded shank of a bolt oppositely dispose a head thereof. The socket is capable of removably attaching to a handle.

Technical aspects of the socket, tool, and method described above preferably include the capability of causing relative rotation between two threaded components, such as a bolt and a nut threaded onto the bolt, preferably despite relatively significant forces being required to cause such relative rotation, such as when the nut is rusted on the bolt.

Other aspects and advantages of this invention will be further appreciated from the following detailed description.

### BRIEF DESCRIPTION OF THE DRAWINGS

FIG. 1 schematically represents a handheld tool for removing a nut from a bolt in accordance with a nonlimiting embodiment of the present invention.

FIG. 2 schematically represents a handheld tool for removing a nut from a bolt in accordance with another nonlimiting embodiment of the present invention.

FIG. 3 schematically represents a handheld tool for removing a nut from a bolt in accordance with yet another nonlimiting embodiment of the present invention.

### DETAILED DESCRIPTION OF THE INVENTION

This disclosure relates to a handheld tool intended for decoupling two threadably coupled components in which one of the components is prone to rotating with the second component when attempting to remove the second component from the first, for example, when attempting to remove a nut of a nut and bolt assembly. For convenience, the tool will be discussed in reference to a bolt having a head fixed to a shank, and external threads that are located along an exterior surface of the shank and configured to threadably couple with complementary internal threads of a nut. The head of the bolt is configured to permit the bolt to be gripped to enable the bolt to be rotated and/or to prevent its rotation, or is configured to inhibit the rotation of the bolt in the part in which the bolt is assembled. However, it will be understood that the teachings disclosed herein are applicable to a variety of components and fasteners that include two components that are decoupled from one another by rotating the components relative to each other.

The handheld tool is particularly useful for removing a nut from a bolt in a situation wherein upon application of a rotational force on the nut, the bolt rotates with the nut rather than the nut rotating on the threads of the bolt. For example, the tool may be used to assist a user who needs to remove a nut that is rusted or otherwise held fast on a bolt, for example, when the user cannot grab and hold the head of the bolt, such as when the head is stripped or rounded or the head cannot be physically accessed due to obstructions. The handheld tool provides the ability for the user to hold the threaded shank of the bolt without damaging the threads on the shank.

The tool includes a socket that has an interior wail that defines an interior surface on which internal threads are formed that are configured to mate with the external threads on the shank of a bolt. The socket includes an open end having an opening into which a distal end of the bolt oppositely disposed from the head may be received, a blocked or closed end oppositely disposed from the open end and closed by an interior barrier that prevents the bolt from passing all of the way through the socket, and a cavity or enclosure surrounded by the interior wall of the socket. The cavity, interior surface, and internal threads of the socket all share a common axis that coincides with an axis of rotation of the socket. The cavity of the socket is sized such that, by threading the internal threads of the socket onto the external threads of the bolt (typically either by rotating the socket clockwise or, from the perspective of the socket, rotating the bolt counterclockwise) until a distal end of the bolt encounters the barrier within the cavity of the socket, only a distal portion of the bolt is within the cavity. At that point, maintaining clockwise rotation force on the socket tool preferably prevents the bolt from rotating when a rotational force is applied to the nut in the opposite (typically counterclockwise) rotational direction. Thus, the nut may be removed from the bolt without damaging the threads, even if the head of the bolt cannot be held to prevent its rotation with the nut.

Although the socket may have a variety of shapes, the shape of its interior wall is preferably cylindrical or tubular. In preferred embodiments, the interior wall of the socket is threaded according to a Unified Thread Standard such as, but not limited to, a UNC (e.g., coarse) standard.

The closed end of the socket may be partially or completely closed by the interior barrier of the socket. For example, the closed end may be only partially closed by the interior barrier to promote cleaning of the cavity within the socket. However, the closed end must be sufficiently blocked to prevent the distal end of the bolt from passing all of the way through and past the socket. Specifically, the shank must be blocked by the interior barrier at the closed end so that the bolt cannot continue to rotate within the socket after encountering the interior barrier, thus holding the shank as long as threading pressure (e.g., a force which prevents rotation of the socket) is maintained on the tool.

The cavity of the socket preferably has a relatively shallow axial depth (i.e., the dimension from the opening at the open end of the socket to a surface of the interior barrier within the cavity) to enable the tool to be used in limited spaces. For example, the socket preferably has an axial depth of not more than about one inch (2.5 cm), and more preferably between about 0.25 inch and 0.75 inch (0.6 to 1.9 cm). More preferably the axial depth of the socket is sufficiently deep to accommodate about two or three external threads at the distal end of the bolt, for example, about 0.25 inch to 0.5 inch (0.6 to 1.3 cm).

The handheld tool preferably includes a handle to which the socket can be removably attached and is configured to rotate the socket about its axis of rotation. Rotating the socket around its axis of rotation threads the bolt into the socket when properly positioned. Continuing to rotate the socket about its axis of rotation when a bolt is being threaded therein will continue to pull the bolt into the socket until the distal end of the bolt contacts and is blocked by the barrier at the closed end of the socket.

If the nut and bolt are caused to rotate relative to each other, either by further applying a rotational force to the socket while the nut is held in position or holding the socket in position while an opposite rotational force is applied to the nut, further relative rotation will tend to cause the nut to rotate on the threads of the bolt shank, for example, by breaking the nut free from the rust, debris, or other obstruction that previously prevented its removal. The nut can continue to be unthreaded from the bolt until it approaches the distal portion of the bolt received in the cavity of the socket, at which point the socket of the tool can be removed from the distal end and, in many cases, the nut can be completely removed from the bolt.

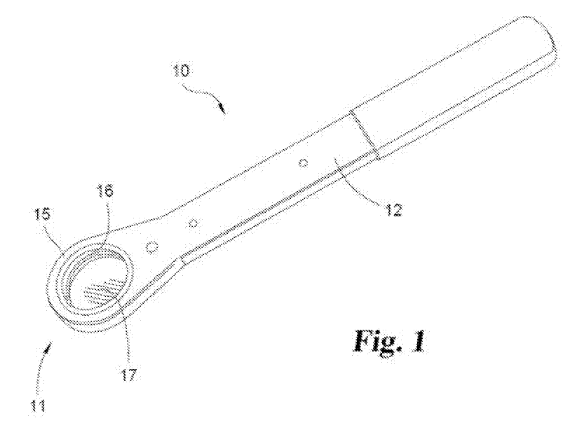

In some embodiments, the tool may be formed as a single integral piece (i.e., the socket is integral with the handle so that the tool is an integral single-piece article) having a socket end and a handle end. FIG. 1 schematically represents a nonlimiting example of a handheld tool 10 for removing a nut from a bolt in accordance with the above-described “single-piece” embodiment. The tool 10 includes a socket end 11 and a handle end 12. The socket end 11 includes an open end 15, an interior wall 16 on which internal threads are formed, a cavity surrounded by the interior wall 16, and a barrier 17 within the cavity and defining a closed end of the socket end 11.

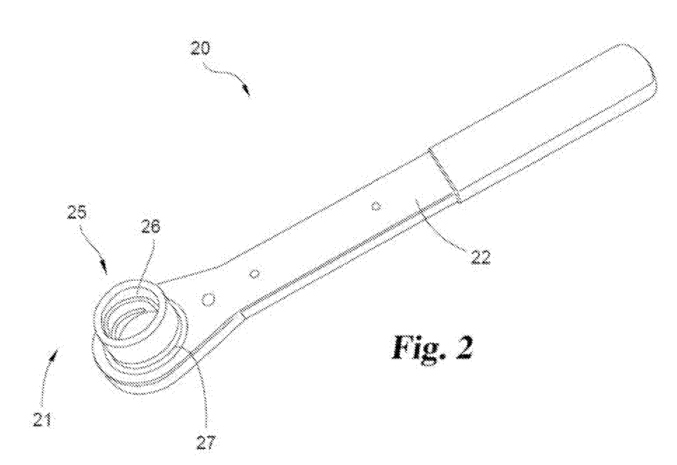

In other embodiments, the tool may be an assembly of multiple components with one or more sockets that are either permanently or removably fixed to the handle (e.g., similar to common socket sets). In an embodiment wherein the socket is removable from the handle, the tool is preferably provided with multiple sockets having different sizes (e.g., cavities and open ends having different internal diameters) and thread configurations sized to receive a variety of bolts having different diameters and/or different thread configurations. It is foreseeable and within the scope of the invention that the socket could be configured to couple with a conventional socket wrench or ratchet. FIG. 2 schematically represents a nonlimiting handheld tool 20 for removing a nut from a bolt in accordance with the above-described “multiple-piece” embodiment. The tool 20 includes a socket end 21 and a handle end 22. The socket end 21 includes a removable socket 25 having an open end, an interior wall 26 on which internal threads are formed, a cavity surrounded by the interior wall 26, and a barrier 27 within the cavity and defining a closed end of the socket end 21.

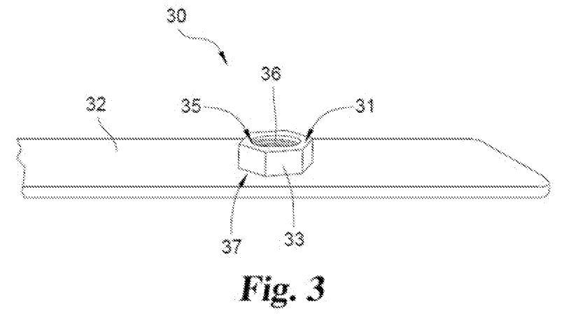

FIG. 3 schematically represents another nonlimiting handheld tool 30 for removing a nut from a bolt in accordance with the “single-piece” embodiment. The tool 30 includes a socket portion 31 and a planar handle 32. In the illustrated embodiment, the socket portion 31 comprises a nut 33 fixedly attached (e.g., such as by welding) to the handle 32. The nut 33 has an opening 35, an interior wall 36 on which internal threads are formed, and a cavity surrounded by the interior wall 36. The portion of handle 32 attached to the nut 33 at its axial end opposite the opening 35 serves as a barrier 37 that defines a closed end of the nut 33.

The tools 10, 20, and 30 and their components may be formed of any materials sufficiently strong for the intended purpose of the tools 10, 20, and 30. For example, in a situation in which a nut is threaded on a bolt, the bolt is desired to rotate rather than the nut to threadably decouple the bolt from the nut, and the nut is held fast to the bolt due to rust or the like, the tool 10, 20, and 30 must be capable of, in combination with a wrench or other means of applying rotational force, applying sufficient rotational force to the bolt such that the nut is dislodged and can be threadably decoupled from the bolt. Nonlimiting materials include a variety of steels, such as AISI 8650 steel.

In view of the above, it will be appreciated that this disclosure provides tools capable of removing a nut that is difficult to remove from the threads of a bolt. Methods of using such tools include threadably coupling the socket of the tool on a distal end of the bolt until the socket is firmly fixed relative to the bolt, holding the nut, for example, with a wrench or the like, and then simultaneously applying counter-rotational forces to the socket and the nut such that the nut and bolt are forced to rotate relative to each other so that the nut moves linearly along the longitudinal axis of the shank (e.g., along the bolt threads).

While the invention has been described in terms of specific or particular embodiments, it should be apparent that alternatives could be adopted by one skilled in the art. For example, the tools 10, 20, and 30 and their respective components could differ in appearance and construction from the embodiments described herein and shown in the drawings, functions of certain components of the tools 10, 20, and 30 could be performed by components of different construction but capable of a similar (though not necessarily equivalent) function, and various materials could be used in the fabrication of the tools 10, 20, and 30 and/or their components. In addition, the invention encompasses additional or alternative embodiments in which one or more features or aspects of a particular embodiment could be eliminated or two or more features or aspects of different disclosed embodiments could be combined. Accordingly, it should be understood that the invention is not necessarily limited to any embodiment described herein or illustrated in the drawings. It should also be understood that the terminology employed above are for the purpose of describing the illustrated embodiments, and do not necessarily serve as limitations to the scope of the invention. Therefore, the scope of the invention is to be limited only by the following claims.

1. A tool for decoupling first and second components that are threadably coupled to each other, the tool comprising:
a socket having an open end having an opening sized to receive at least a distal portion of the first component that has first threads thereon, a closed end oppositely disposed from the open end, and an interior wall therebetween that defines a cavity within the socket, an interior surface of the interior wall having second threads thereon configured to threadably couple with the first threads of the first component, the socket having an axis of rotation; and
a handle configured for rotating the socket about its axis of rotation.

2. The tool of claim 1, wherein the cavity of the socket has an axial dimension between the open end and the closed end of not more than 2.5 cm.

3. The tool of claim 1, wherein the interior surfaces of the socket are threaded to a UNC standard.

4. The tool of claim 1, wherein the socket is integral with the handle.

5. The tool of claim 4, wherein the socket comprises a nut fixed to a surface of the handle.

6. The tool of claim 1, wherein the socket is removably attached to the handle.

7. The tool of claim 1, wherein the first component is a bolt having a head and a shank having the first threads thereon, and the second component is a nut threadably coupled on the shank of the bolt, the socket being configured to receive and threadably couple with a distal end of the shank oppositely disposed from the head.

8. A method of using the tool of claim 1, the method comprising:
inserting the distal portion of the first component into the opening of the open end;
rotating the socket about the axis of rotation thereof to threadably couple the socket to the first component;
continuing to rotate the socket until a distal end of the first component contacts a barrier at the closed end; and then
simultaneously applying counter-rotational forces to the socket and the second component to cause relative rotation of the first and second components such that the second component threadably decouples from the first component.

9. A method of decoupling first and second components that are threadably coupled, the method comprising:
providing a tool comprising:
a socket having an open end having an opening, a closed end oppositely disposed from the open end, and an interior wall therebetween that defines a cavity within the socket; and
a handle configured for rotating the socket about an axis of rotation thereof;
inserting at least a distal portion of the first component having first threads thereon into the opening of the open end of the socket;
rotating the socket about an axis of rotation thereof to threadably couple second threads on an interior surface of the interior wall of the socket with the first threads of the first component;
continuing to rotate the socket until a distal end of the first component contacts a barrier at the closed end; and then
simultaneously applying counter-rotational forces to the socket and the second component to cause relative rotation of the first and second components such that the second component threadably decouples from the first component.

10. The method of claim 9, wherein the socket is removably attached to the handle, the method further comprising securing the socket to the handle at least prior to applying the counter-rotational force.

11. The method of claim 10, further comprising choosing the socket from a plurality of threaded sockets configured to removably attach to the handle.

12. The method of claim 9, wherein the first component is a bolt having a head and a shank having the first threads thereon, and the second component is a nut threadably coupled on the shank of the bolt, the method comprising inserting and threadably coupling a distal end of the shank oppositely disposed from the head into the open end of the socket.

13. A socket configured to couple with a tool, the socket comprising:
an open end having an opening;
a closed end oppositely disposed from the open end;
an interior wall between the open end and the closed end that defines a cavity, the interior wall having an interior surface having threads thereon configured to threadably couple with a distal end of a threaded shank of a bolt oppositely dispose a head thereof; and
means for removably attaching to a handle.

14. The socket of claim 13, wherein the socket has an inside dimension from the open end to the closed end of no more than 2.5 cm.

15. The socket of claim 13, wherein the interior surface of the interior wall is threaded to a UNC standard.

16. A method of using the socket of claim 13 to remove a nut threadably coupled to the bolt, the method comprising:
inserting the distal end of the bolt into the opening of the open end of the socket;
rotating the socket about an axis of rotation thereof to threadably couple the socket to the bolt;
continuing to rotate the socket until the distal end of the bolt contacts a barrier at the closed end of the socket; and then
simultaneously applying counter-rotational forces to the socket and the nut such that the nut threadably decouples from the bolt.
